(19) United States
(12) Patent Application Publication
(10) Pub. No.: US 2008/0200147 A1
(43) Pub. Date: Aug. 21, 2008

(54) Authentication of Mobile Communication Networks

(76) Inventors: Tomas Nylander, Varmdo (SE); Jari Vikberg, Jarna (SE); Lars Peter Ohman, Enebyberg (SE)

Correspondence Address: NIXON & VANDERHYE, PC, 901 NORTH GLEBE ROAD, 11TH FLOOR, ARLINGTON, VA, 22203, US

(21) Appl. No.: 11/628,463

(22) PCT Filed: Jun. 4, 2004
(86) PCT No.: PCT/EP04/06077

§ 371 Date: Dec. 7, 2007

(51) Int. Cl. H04M 1/66; H04M 1/00

(52) U.S. Cl. 455/411; 455/558

(57) ABSTRACT

A mobile station is adapted to communicate with a core network portion of a mobile communications network via an unlicensed radio access network. The mobile station has a SIM card adapted to generate a unique response word using at least a key unique to the mobile station and a fixed length random number. The mobile station includes processing circuitry and unlicensed radio interface circuitry coupled to the processing circuitry. This circuitry is adapted to generate a fixed-length random number, calculate a first response word with the SIM card on the basis of the generated random number, formulate and transmit an authentication request to the unlicensed radio access network containing the fixed-length random number, receive an authentication response from the unlicensed radio access network containing a second response word, and compare the calculated first response word with the received second word to authenticate said core network. In this manner, mobile station is able to authenticate the network with an existing second-generation SIM card and with minimum modification of its operation.

### FIELD OF INVENTION

The present invention relates to authentication between a mobile station and a mobile communications network. The present invention has particular relevance to mobile communication networks accessed via unlicensed radio access networks.

### BACKGROUND ART

In many second-generation mobile networks, such as GSM networks, authentication mechanisms provide a way for the network to authenticate mobile stations that attempt to connect to the network. The existing GSM authentication mechanism is based on a challenge-response exchange between the network and mobile station.

A mobile services switching center MSC initiates the authentication procedure when this is required, e.g. when receiving a location update message, a CM service request for a mobile originating call, a SMS or paging response from a mobile station or the like. An authentication center (AUC) connected to the mobile services switching center MSC via a home location register HLR holds the mobile station IMSI values in associated with a secret key Ki and also contains an algorithm called the A3 algorithm. The subscriber identification module or SIM card provided in each mobile station is also programmed with the operator specific A3 authentication algorithm and the secret key Ki. Authentication is started by the authentication center AUC generating a 128-bit random number RAND, which is communicated to the mobile services switching center MSC and by the MSC to the mobile station in an authentication request message. The authentication center AUC then uses this random number RAND together with the mobile station IMSI and the key Ki as input values to the A3 algorithm to generate a response SRES. This value is communicated to the mobile services switching center MSC.

The SIM card in the mobile station likewise performs the A3 algorithm with the IMSI, key Ki and communicated random number RAND as input to generate a response SRES, which is communicated to the MSC in an authentication response message. The mobile services switching center MSC compares the SRES values received respectively from the mobile station and the authentication center AUC. If these values are the same, authentication is successful. If the values differ from one another, access to the core network by the mobile station is denied.

The procedures available in second-generation networks and mobile stations do not permit the mobile station to authenticate the mobile network. While in many cases this reverse authentication is not required, there are occasions when the mobile station needs to ensure that the mobile network is not hostile. One example is when the mobile station accesses a mobile core network using an unlicensed radio access network. These access networks typically comprise an access controller connected to a node of the core network of the cellular mobile communication systems over a conventional network interface (e.g. the A-interface or Gb interface for a GSM network). When viewed from the core network portion, this access controller appears very much like a base station subsystem of a conventional access network. The access controller is connected to a plurality of low-power unlicensed radio transceivers, or access points, each capable of supporting unlicensed radio connections with mobile stations MS. Suitable unlicensed-radio formats include digital enhanced cordless telecommunications (DECT), wireless LAN and Bluetooth. The access points are preferably connected to the access controller via a broadband packet-switched network. Ideally, the access network exploits an already existing broadband network having suitable unlicensed radio access points typically provided to enable a subscriber to access the Internet. A mobile station capable of setting up an unlicensed radio link with an access point can then establish a connection with the access controller via the broadband network. An unlicensed radio access network of this kind is described in European patent application No. 00 125 076.0.

The unlicensed radio access network may not be operated by the mobile core network operator, hence there is a need for the mobile station to authenticate the core network it is given access to. This is still more important when an unlicensed radio access network provides access to several licensed mobile networks.

The authentication procedure specified for third generation mobile networks does permit mutual authentication. However, this procedure is valid only for third generation SIM cards. This procedure can only be implemented by replacing the existing base of second-generation SIM cards.

### SUMMARY OF THE INVENTION

In the light of the above problems it is an object of the present invention to enable a mobile station to authenticate a mobile network without having to replace its second-generation SIM card.

This and other objects and advantages are achieved in a mobile station, a method of authenticating a network in a mobile station and a method of handling an authentication request in accordance with the appended claims.

Specifically, the invention resides in a mobile station adapted to communicate with a core network portion of a mobile communications network via an unlicensed radio access network. The mobile station has a SIM card adapted to generate a unique response word using at least a key unique to the mobile station and a fixed length random number. The mobile station includes processing circuitry and unlicensed radio interface circuitry coupled to the processing circuitry. This circuitry is adapted to generate a fixed-length random number, calculate a first response word with the SIM card on the basis of the generated random number, formulate and transmit an authentication request to the unlicensed radio access network containing the fixed-length random number, receive an authentication response from the unlicensed radio access network containing a second response word, and compare the calculated first response word with the received second word to authenticate said core network. In this manner, the mobile station essentially replicates the authentication procedure carried out by the mobile network but controls the process by generating the random number used to generate the authentication code. The mobile station is thus able to authenticate the network with an existing second-generation SIM card and with minimum modification of its operation.

The invention also resides in method of authenticating a mobile communications network using a mobile station adapted to communicate with a core network portion of a GSM mobile communications network via an unlicensed radio access network. The mobile station has a SIM card that is arranged to generate a unique response word using a fixed length random number. The method includes the following steps: generating a fixed length random number in the mobile station, transmitting an authentication request message including the fixed length random number to the unlicensed radio access network, using the SIM card to calculate a first response word using the generated fixed length random number, receiving an authentication response message from the unlicensed radio access network, this authentication response message including a second response word, comparing the first response word with the second response word and authenticating the mobile communications network when the first and second response words match. The authentication request may either be directed to the unlicensed radio access network, in which case it can be generated using a radio resource protocol. Alternatively, the authentication request is directed to a node of the core network, in which case it is generated using a mobility management protocol, which is relayed within the unlicensed radio access network and consequently essentially transparent to this network.

In accordance with a further aspect, the invention resides in a method of handling an authentication request from a mobile station by an access controller of an unlicensed radio access network. The access controller is adapted to communicate with the core network portion of a mobile communications network and with at least one access point that is connected to mobile stations over an unlicensed radio interface via a broadband network. This method includes the following steps: receiving an authentication request including a fixed length random number from a mobile station, transmitting the fixed length random number to an authentication center in the core network portion, receiving a unique response word from the authentication center, the unique response word being calculated on the basis of the fixed length random number, and transmitting an authentication response including the unique response word to the mobile station.

In accordance with an alternative embodiment, the invention resides in a method of handling an authentication request from a mobile station by a switching node of a mobile communications network. The switching node is adapted to communicate with mobile stations via an unlicensed radio access network having an access controller and at least one access point that is connected to mobile stations over an unlicensed radio interface. The method includes the following steps: receiving an authentication request including a fixed length random number from a mobile station, transmitting the fixed length random number to an authentication center, receiving a unique response word from the authentication center, the unique response word being calculated on the basis of the fixed length random number, and transmitting an authentication response including the unique response word to the mobile station.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically depicts parts of a GSM network with an unlicensed-radio access network,

FIG. 2 is a block diagram schematically depicting the functional layout of a mobile station in accordance with the present invention, and

FIG. 3 is a signalling diagram showing the signalling between a mobile station and second-generation core network for mutual authentication.

### DETAILED DESCRIPTION OF THE DRAWINGS

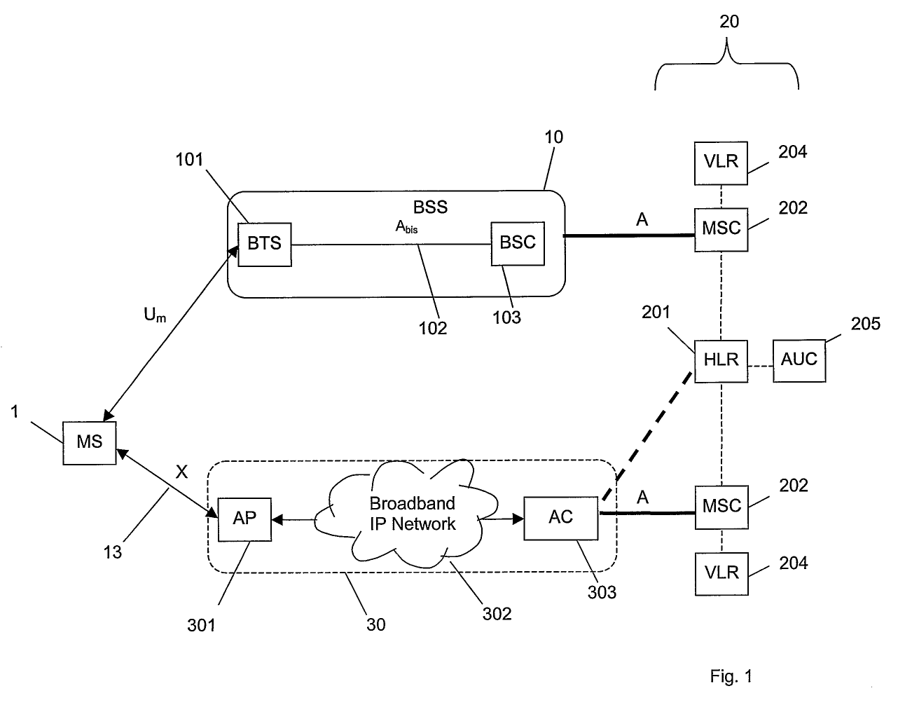

FIG. 1 schematically depicts parts of a conventional GSM network. This network is essentially divided into a core network portion 20 and an access portion also known as a base station subsystem BSS 10. The elements of the core network 20 illustrated in the figure include the mobile switching centers or MSCs 202, associated home location register HLR 201 and visitor location register VLR 204. The function and structure of these conventional GSM architecture elements are known to those skilled in the art and will not be described in further detail here. Although not shown in the figure, it will be understood by those skilled in the art that the core network portion may include access to other mobile and fixed-line networks, such as ISDN and PSTN networks, packet and circuit switched packet data networks such as intranets, extranets and the Internet through one or more gateway nodes. Also illustrated in the figure is the Authentication Center AUC 205, which is connected to the home location register HLR.

The access portion essentially consists of base station subsystems BSS 10, one of which is illustrated in FIG. 1, which communicate via defined fixed standard A interfaces with MSCs 202 in the core network portion 20. Each base station subsystem BSS 10 includes a base station controller BSC 103 which communicates with one or more base transceiver stations BTS 101 via the defined A_{bis} air interface 102. The base transceiver stations 101 communicate with mobile stations MS 1 over the GSM standard Uₘ radio air interface. It will be understood that while the BTS 101 and BSC 103 are depicted as forming a single entity in the BSS 10, the BSC 103 is often separate from the BTSs 101 and may even be located at the mobile services switching centre MSC 202.

In addition to the standard access network portion provided by the BSS's 10 the network depicted in FIG. 1 further includes a modified access network portion 30 shown in the lower half of the figure. Hereinafter this will be described as an unlicensed-radio access network portion.

The components making up this unlicensed-radio access network portion 30 also enable the mobile station 1 to access the GSM core network portion, and through this, other communication networks via an unlicensed-radio interface X, represented in FIG. 1 by the bi-directional arrow 13. By unlicensed-radio is meant any radio protocol that does not require the operator running the mobile network to have obtained a license from the appropriate regulatory body. In general, such unlicensed-radio technologies must be low power and thus of limited range compared to licensed mobile radio services. This means that the battery lifetime of mobile stations will be greater. Moreover, because the range is low, the unlicensed-radio may be a broadband radio, thus providing improved voice quality. The radio interface may utilise any suitable unlicensed-radio protocol, for example a wireless LAN (W-LAN) protocol or Digital Enhanced Cordless Telecommunications (DECT). Preferably, however, Bluetooth radio is utilised, which has a high bandwidth and lower power consumption than conventional public mobile network radio.

The Bluetooth standard specifies a two-way digital radio link for short-range connections between different devices. Devices are equipped with a transceiver that transmits and receives in a frequency band around 2.45 GHz. This band is available globally with some variation of bandwidth depending on the country. In addition to data, up to three voice channels are available. Each device has a unique 48-bit address from the IEEE 802 standard. Built-in encryption and verification is also available.

The access network portion 30 is accessed via access points AP 301 that are adapted to communicate across the Bluetooth interface. Only one access point AP 301 is illustrated in FIG. 1, but it will be understood that many hundreds of these elements may be included in the unlicensed-radio access network 30. This element handles the radio link protocols with the mobile station MS 1 and contains radio transceivers that define a cell in a similar manner to the operation of a conventional GSM base station transceiver BTS 101. All communication via the access points AP 301 is controlled by an access controller AC 303, which communicates with a mobile service switching centre MSC 202 over the GSM standard A interface. The access controller AC 303 provides the connection between the MSC 202 and mobile station 1. The joint function of the access point AP 301 and the access controller AC 303 emulates the operation of the BSS 10 towards the MSC 202. In other words, when viewed from the elements of the core network 20 such as the mobile service switching centre MSC 202, the access network portion 30 constituted by the access points AP 301 and the access controller AC 303 looks like a conventional access network portion 10.

The interface between the access point AP 301 and the access controller AC 303 is provided by a packet-switched broadband network, which may be a fixed network. The access point 301 is intended to be a small device that a subscriber can purchase and install in a desired location such as the home or an office environment to obtain a fixed access to the mobile network. However, they could also be installed by operators in traffic hotspots. In order to reduce the installation costs on the part of the operator, the interface between the access point 301 and the access controller 303 preferably exploits a connection provided by an already existing network 302. Suitable networks might include those based on ADSL, Ethernet, LMDS, or the like. Home connections to such networks are increasingly available to subscribers while access points to such networks are becoming widespread in public and commercial buildings. Although not shown in FIG. 1, the access point AP 301 will be connected to a network terminal giving access to the network 302, while the access controller AC 303 may be connected to an edge router ER of the network 302 that also links the network 302 to other networks such as intranets and the internet. The Internet protocol, IP, is used for communication over the network 302 to render the transport of data independent of the network type.

The access point AP 301 may serve as a dedicated access point to the unlicensed-radio access network. In this case the access point AP 301 is capable of communicating independently with the mobile station 10 over the unlicensed-radio interface X or with the access controller 303 over the broadband network interface 302. The access point AP 301 utilises the standard protocols and functions to ascertain to which access controller AC 303 it should connect, and also to establish a connection and register with this access controller AC 303.

In an alternative embodiment, the access point 301 serves as an essentially transparent access point when viewed both from the access controller 303 and the mobile station 1. In other words, this access point relays all information at the IP level and above between the mobile station 1 and the access controller 303. It simply effects the conversion between the OSI reference model layer 1 and 2 unlicensed-radio and terrestrial access layer services. Accordingly, the mobile station 1 establishes a connection with the access controller 303 without recognising the access point as a node in the connection. Similarly the access controller 303 could establish a connection with the mobile station 1 directly.

The link between the mobile station MS 1 and the access controller AC 303 over the broadband IP network 302 is always open, so that this connection is always available without the need for reserving a channel. Specifically, a transport protocol is utilised that maintains a connection state between a mobile station MS 1 and the access controller AC 303. One suitable transport protocol is the Transmission Control Protocol (TCP), however, other protocols such as the User Datagram Protocol (UDP) or the Signalling Control Transfer Protocol could also be used. While the network 302 is preferably an IP-based network, ATM-based networks could also be used. In particular when DSL technologies are used in this network, they could be used directly on top of the ATM layer, since they are based on ATM. Naturally, an ATM based network could also be used to transport IP, serving as a base layer.

The applications that run on the mobile station MS 1 on top of the public mobile network radio interfaces also run on top of Bluetooth radio between the mobile station 1 and the access point AP 301.

The access point AP 301 is installed by plugging it in to a port of a suitable modem, such as an ADSL or CATV modem, to access the fixed network 302. Alternatively, the access point AP 301 could be integrated in such a modem. The port is in contact with an intranet that is either bridged or routed on the IP level.

In a conventional GSM network or other second-generation public licensed mobile network PLMN a mobile station is authenticated and validated when it registers with a network.

In a GSM system the Authentication Center AUC 205 holds International Mobile Subscriber Identity IMSI values for subscribers to the network and also the permanent key Ki of each subscriber's SIM card. The authentication center AUC 205 also holds an algorithm A3 that uses the permanent key Ki and a 128-bit random number as input to calculate a 32-bit response SRES. The A3 algorithm is also held in the subscribers SIM cards. On receipt of a request from the mobile services switching center MSC 202 identifying a mobile station using the IMSI, the authentication center AUC 205 generates a 128-bit random number RAND, calculates the response using this number, the IMSI and the associated permanent key Ki as input to the A3 algorithm and transmits the random number, RAND, the permanent key Ki and the calculated response SRES to the mobile services switching center MSC 202.

The mobile services switching center MSC 202 sends an authentication request message to the mobile station 1 including the random number RAND obtained from the authentication center AUC 205. The A3 algorithm on the mobile station SIM card is then triggered to calculate a response using the received random number RAND, the IMSI and the permanent key Ki. The generated response SRES is then communicated to the mobile services switching center MSC 202 which compares this value with the response received from the authentication center AUC 205. The mobile station 1 is authenticated if the values match.

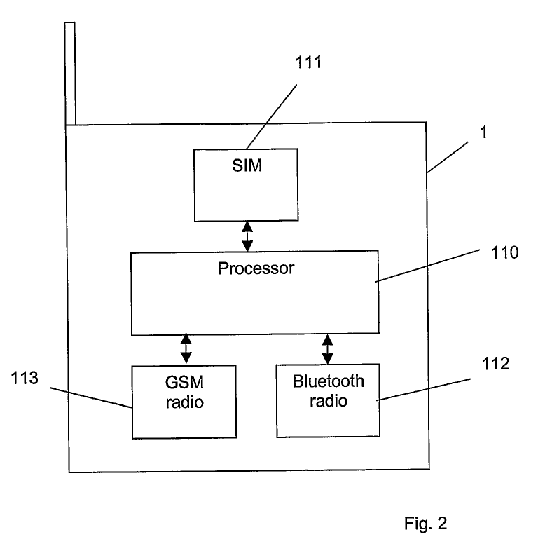

In accordance with the present invention, this procedure is supplemented with a reverse authentication of the core network initiated by the mobile station 1. Turning now to FIG. 2 there is shown a block diagram representing the functional elements of a mobile station 1 capable of accessing the core network 20 via either the conventional base station subsystem 10 or via the unlicensed radio access network 30. It will be understood that this diagram of FIG. 2 is very simplified showing only those elements that are relevant for understanding the present invention. The mobile station 1 comprises processor circuitry 110 that interfaces with both GSM radio circuitry 113 and Bluetooth radio circuitry 112 depending on how the mobile station is connected to the core network portion. A SIM card 111 is likewise connected to the processor circuitry 110. During the mobile station authentication procedure described above, the processor circuitry receives the 128-bit random number RAND via the Bluetooth radio circuitry 112 and forwards this to the SIM card to generate the 32-bit response SRES, which is then transmitted back to the core network 20. In accordance with the present invention, the processor circuitry 110 in the mobile station 1 itself generates a 128-bit random number RAND_{mob} and transmits this to the SIM card for the calculation of a corresponding 32-bit response SRES_{mob}. The processor circuitry 110 retrieves the IMSI from the SIM card and formulates an authentication request containing the 128-bit random number RAND_{mob} and the IMSI to be sent to the core network via the Bluetooth radio circuitry 112 and interface 13. In response to this request, the core network 20, or more specifically the mobile services switching center MSC 202, communicates the random number RAND_{mob} generated in the mobile station and the IMSI associated with this mobile station 1 to the authentication center 205 either directly or via the home location register 201. The authentication center 205 retrieves the correct permanent key Ki associated with the IMSI and performs the A3 algorithm on this key Ki, the IMSI and the random number RAND_{mob} to generate a 32 bit response SRES_{mob}, which is communicated to the mobile services switching center MSC 202. This node then sends an authentication response message to the mobile station 1 containing the calculated response SRES_{mob}. On receipt of this response value SRES_{mob} via the Bluetooth radio circuitry 112, the processing circuitry compares this value with the value calculated by the SIM card. If these match, the network is authenticated.

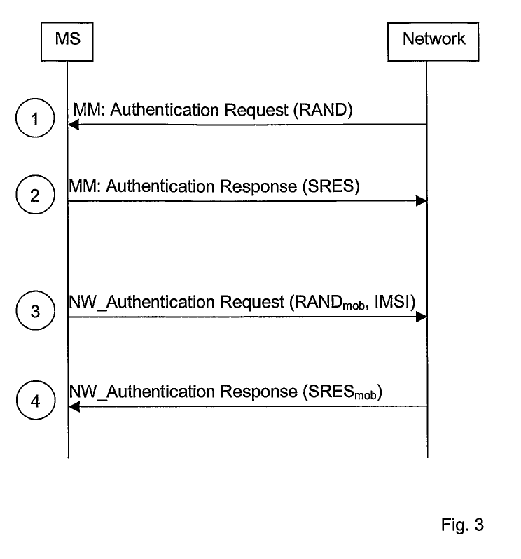

The signalling between a mobile station and the core network for this mutual authentication is illustrated in FIG. 3. The initial authentication procedure is the standard GSM authentication of the mobile station consisting of an authentication request at event 1 sent by the core network 20 to the mobile station 1 and containing the 128-bit random number generated by the authentication center AUC 205, and an authentication response at event 2 from the mobile station 1 to the core network 20 containing the 32-bit response calculated using the A3 algorithm an IMSI value stored in the mobile station SIM card 111. Only when this procedure has been successfully completed can the mobile station commence the authentication of the network. These messages are sent using the mobility management protocol directly between the mobile station 1 and mobile services switching center 202. The unlicensed radio access network 30 relays all mobility management messages and other layer 3 messages between the mobile station and the core network 20. The only messages to be processed within the unlicensed radio access network are radio resource messages and lower layer messages within the ISO protocol stack. All higher layer messages are relayed transparently from the mobile station to the core network 20. It is important that the mobile station authentication is carried out first to prevent hostile mobile stations from using the reverse procedure to obtain a 32-bit response that could subsequently be used to authenticate it with the network. The reverse authentication procedure commences at event 3 with the transmission by the mobile station 1 of a network authentication request containing the random number RAND_{mob} generated in the mobile station together with the IMSI. After calculating a 32-bit response, the network responds with a network authentication response containing the 32-bit response value SRES_{mob} at event 4. A mobility management protocol may also be used for these messages as they are exchanged directly between the mobile station 1 and the mobile services switching center MSC 202 of the core network 20.

It will be understood that the above-described procedure requires some modification of mobile services switching centers 202 within the GSM network to recognise the authentication request from a mobile station, to formulate a new request to the authentication center AUC 205 supplying an externally generated random number and to formulate an authentication response. In accordance with an alternative embodiment, the network authentication messages are exchanged between the mobile station 1 and the access controller AC 303 of the unlicensed radio access network 30. The access controller AC 303 receives the random number from the mobile station 1 and transmits this to the authentication center AUC 205 via the home location register HLR 201 together with the IMSI via a modified direct interface with the latter illustrated by a dashed line in FIG. 1. The authentication center AUC 205 and home location register HLR 201 return the calculated 32-bit response directly to the access controller AC 303 bypassing the mobile services switching center MSC 202. Alternatively, another node in the core network could be arranged to implement the functionality of the authentication center AUC 303, in which case this exchange of data will take place between the access controller AC 303 and this modified node. This means that the modification of the GSM core network is limited to the interface and function of the authentication center AUC 205 and home location register HLR 201. The mobile services switching center MSC 202 is unaware of this reverse authentication procedure. In this case, the signalling illustrated at events 3 and 4 in FIG. 3 occurs between the mobile station 1 and the access controller AC 303 using a suitable radio resource protocol carried over the Bluetooth radio interface and the IP network 302.

In the above, the invention has been described with reference to a mobile station 1 communicating with a mobile services switching center MSC 202 in the core network. It will be understood that the node with a mobile station communicates depends on the type of service utilised and data exchanged. For example for packet data services such as the General Packet Radio Service GPRS the mobile station will communication with, be authenticated by and authenticate a GPRS support node SGSN. Similar considerations apply to the authentication of other second-generation mobile networks.

1. A mobile station adapted to communicate with a core network portion (20) of a mobile communications network via an unlicensed radio access network (30), said mobile station having a SIM card (111) adapted to use an authentication algorithm, a key unique to said mobile station (1) and a first fixed length random number received from said core network in an authentication request to generate a first unique response word for authenticating said mobile station with said core network, characterised in that said mobile station includes processing circuitry (110) and unlicensed radio interface circuitry (112) coupled to said processing circuitry (110), said processing and unlicensed radio interface circuitry being adapted to generate a second fixed-length random number and to formulate and transmit an authentication request to said unlicensed radio access network (30) containing said second fixed length random number,
said SIM card being adapted to calculate a second response word on the basis of said generated second random number using said authentication algorithm and said unique key,
said processing circuitry (110) and unlicensed radio interface circuitry (112) being further adapted to receive an authentication response from said unlicensed radio access network (30) containing a third response word, and compare said calculated second response word with said received third word to authenticate said core network (20).

2. A mobile station as claimed in claim 1, characterised in that it is adapted to communicate with a core network portion of a GSM mobile communications network via said unlicensed radio access network.

3. A mobile station as claimed in claim 1, characterised in that said unlicensed radio interface circuitry (112) is adapted to transmit and receive information via a Bluetooth radio interface.

4. A mobile station as claimed in claim 1, characterised in that said processing and unlicensed radio interface circuitry (110, 112) is adapted to formulate and transmit an authentication request using a mobility management protocol destined for said core network (20).

5. A mobile station as claimed in claim 1, characterised in that said processing and unlicensed radio interface circuitry (110, 112) is adapted to formulate and transmit an authentication request using a radio resource protocol destined for said unlicensed radio access network (30).

6. A method of authenticating a mobile communications network using a mobile station (1) adapted to communicate with a core network portion (20) of said mobile communications network via an unlicensed radio access network (30) and having a SIM card (111), wherein said SIM card is arranged to use an authentication algorithm, a key unique to said mobile station (1) and a first fixed length random number received from said core network in an authentication request to generate a first unique response word for authenticating said mobile station with said core network, said method including:
generating a second fixed length random number in said mobile station,
transmitting an authentication request message including said second fixed length random number to said unlicensed radio access network (30),
using said SIM card to calculate a second response word using said authentication algorithm, said unique key and said generated second fixed length random number,
receiving an authentication response message from said unlicensed radio access network (30), said authentication response message including a third response word, comparing said second response word with said third response word and
authenticating said mobile communications network when said second and third response words match.

7. A method as claimed in claim 6, characterised by using a mobile subscriber identity value to calculate said first and second unique response words with said received and generated fixed length random numbers, respectively.

8. A method as claimed in claim 6, characterised in that the step of transmitting an authentication request message includes using a mobility management protocol to formulate said message.

9. A method as claimed in claim 6, characterised in that the step of transmitting an authentication request message includes using a radio resource protocol to formulate said message.

10. A method as claimed in claim 6, characterised in that mobile communications network is a GSM network.

11. A method of handling an authentication request from a mobile station by an access controller (303) of an unlicensed radio access network (30) said access controller being adapted to communicate with the core network portion (20) of a mobile communications network and with at least one access point (103) that is connected to mobile stations over an unlicensed radio interface (13) via a broadband network (302), said method including the steps of:
receiving an authentication request including a fixed length random number from a mobile station,
transmitting said fixed length random number directly to a home location register connected to an authentication center (205) in said core network portion (20), receiving a unique response word from said authentication center via said home location register, said unique response word being calculated on the basis of said fixed length random number, and
transmitting an authentication response including said unique response word to said mobile station.

12. A method as claimed in claim 11, characterised in that the step of transmitting said fixed length random number to said authentication center (205) includes transmitting a mobile subscriber identity value received in said authentication request.

13. A method as claimed in claim 11, further characterised by the step of authenticating said mobile station prior to accepting said authentication request message.
